(19) United States
(12) Patent Application Publication
(10) Pub. No.: US 2024/0183717 A1
(43) Pub. Date: Jun. 6, 2024

(54) METHOD AND SYSTEM FOR MONITORING PERSONAL ENVIRONMENTAL CONDITIONS USING A MOBILE DEVICE

(71) Applicant: Mobile Physics Ltd., Kfar Saba (IL)

(72) Inventor: Erez WEINROTH, Kfar Saba (IL)

(73) Assignee: Mobile Physics Ltd., Kfar Saba (IL)

(21) Appl. No.: 18/449,835

(22) Filed: Aug. 15, 2023

Related U.S. Application Data
(63) Continuation of application No. PCT/IL2022/050177, filed on Feb. 15, 2022.
(60) Provisional application No. 63/149,369, filed on Feb. 15, 2021.

(51) Int. Cl. G01J 5/00; G01J 1/02; G01J 1/42

(52) U.S. Cl. CPC G01J 5/0025; G01J 1/0219; G01J 1/0228; G01J 1/429; G01J 2001/4266

(57) ABSTRACT

A method and system for personal environmental monitoring using a mobile device are provided herein. The method may include: determining an ultraviolet index, “UVI”, in the vicinity of the mobile device, based on data received from the mobile device; determining a modified UVI, “m-UVI”, based on at least one of further data received from the mobile device and data input by a user of the mobile device; determining a predicted exposure of the user of the mobile device, based on the m-UVI; determining a minimal erythemal dose, “MED”, of the user based on an input skin type of the user; providing an erythema timer based on the m-UVI and the MED; and continually updating the erythema timer based on changing environmental or user conditions, wherein the received data corresponds to at least one of: a current time; a geolocation of the mobile device; and an altitude of the mobile device.

### CROSS REFERENCE TO RELATED APPLICATIONS

This Application is a continuation of PCT Application No. PCT/IL2022/050177 filed on Feb. 15, 2022, which claims the priority of US Provisional Patent Application No. 63/149,369 filed on Feb. 15, 2021, both of which are incorporated herein by reference in their entirety.

### FIELD OF THE INVENTION

The present invention relates generally to applications for personal monitoring of environmental conditions, in particular ultraviolet exposure.

### BACKGROUND OF THE INVENTION

Sunlight encompasses many wavelengths of the electromagnetic spectrum, including ultraviolet light which can be harmful to the human body, e.g., reddening of the skin (erythema), sunburn and potential skin cancer. Ultraviolet (UV) light can be classified into subtypes, for example UV-A are long waves of UV light which are not absorbed by the Earth's ozone layer and occupy wavelengths between 400 and 315 nanometres (nm). UV-B occupies wavelengths between 315 and 280nm and are mostly absorbed by the ozone layer. Both UV-A and UV-B can contribute to erythema, but do not do so equally.

The erythema weighting function w(λ) is defined as follows:

$$w ( λ ) = \{ \begin{matrix}1. & for 250 \leq λ \leq 298 nm \\ {1.}^{0.094 ( 298 - λ )} & for 298 < λ \leq 328 nm \\ {1.}^{0.015 ( 139 - λ )} & for 328 < λ \leq 400 nm \\ 0 & for λ > 400 nm\end{matrix}$$

The Standard Erythemal Dose (SED) is a constant standard unit of accumulated UV radiation energy density. 1 SED is equivalent to an erythemal effective radiant exposure of 100 Jm⁻².

The Minimal Erythemal Dose (MED) is the minimal accumulated UV energy that initiates Erythema. The MED strongly depends on the skin type and varies between 2 SED (200 Jm-2) for the brightest skins, and 20 SED (2000 Jm-2) for darker skins. Skin type can be determined using the Fitzpatrick scale, and the corresponding MED can be determined following past research (e.g. Mckinlay, Risks and Regulations, 1987).

The UV index (UVI) is a linear scale representing the risk of sunburn, varying from 0 (representing no risk, e.g. night-time) to 11+ representing the most risk. The UVI is erythemally weighted using w(λ) but gives an easy-to-understand scale that is widely used to promote public awareness of the risks of UV radiation exposure and sun protection.

UVI can be affected by many factors such as solar zenith angle, total ozone column, altitude, aerosol loading and surrounding surface reflectance (albedo).

Sunlight exposure can have beneficial effects, however. Vitamin D may be produced by skin exposure to UV (UV-B specifically), and therefore it may be useful to provide a vitamin D production efficiency to a user.

### BRIEF SUMMARY OF THE INVENTION

According to a broad aspect of the invention there is provided a method for personal environmental monitoring using a mobile device, the method comprising: using a processor, determining an ultraviolet index, “UVI”, based on data received from the mobile device; determining a modified UVI, “m-UVI”, based on at least one of further data received from the mobile device and data input by a user of the mobile device; using a processor, determining a predicted exposure of the user of the mobile device, based on the m-UVI; using a processor, determining a minimal erythemal dose, “MED”, of the user based on an input skin type of the user; using a processor, providing an erythema timer based on the m-UVI and the MED; and, using a processor, continually updating the erythema timer based on changing environmental or user conditions, wherein the received data corresponds to at least one of: a current time; a geolocation of the mobile device; and an altitude of the mobile device.

Other embodiments of the invention are defined in the appended dependent claims.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limited in the figures or the accompanying drawings, in which like reference numerals indicate corresponding, analogous or similar elements, and in which:

FIG. 1 is a flowchart according to embodiments of the invention;

FIGS. 2A and 2B are high level diagrams of data flows as used by embodiments of the invention;

FIG. 3 is a diagram of an exemplary user interface according to embodiments of the invention; and

FIG. 4 is a high-level block diagram of an exemplary computing device which may be used with embodiments of the present invention.

### DETAILED DESCRIPTION OF THE INVENTION

With specific reference now to the drawings in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

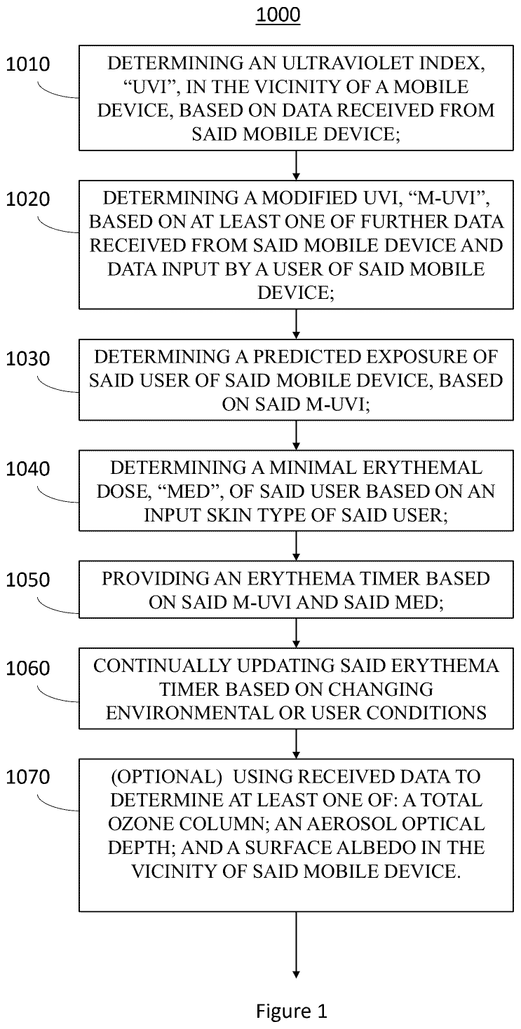

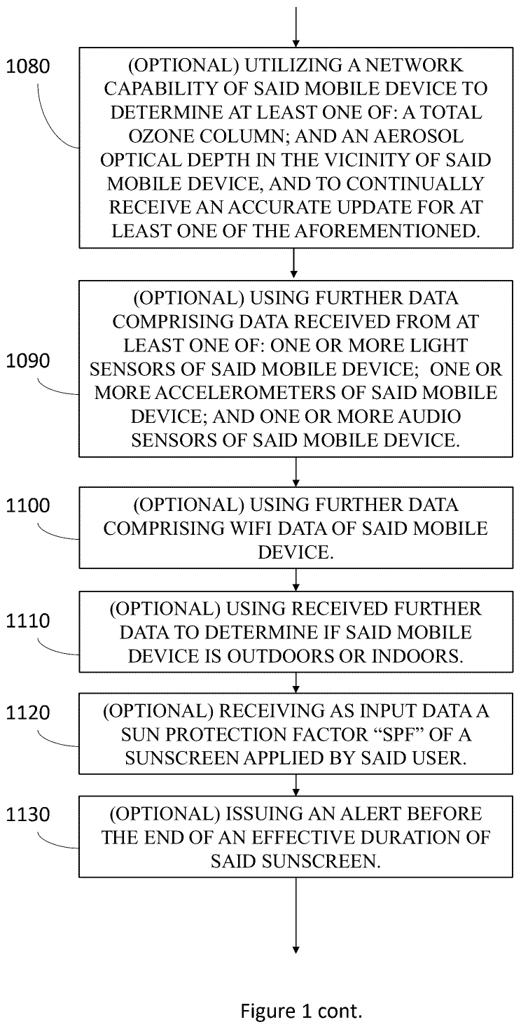

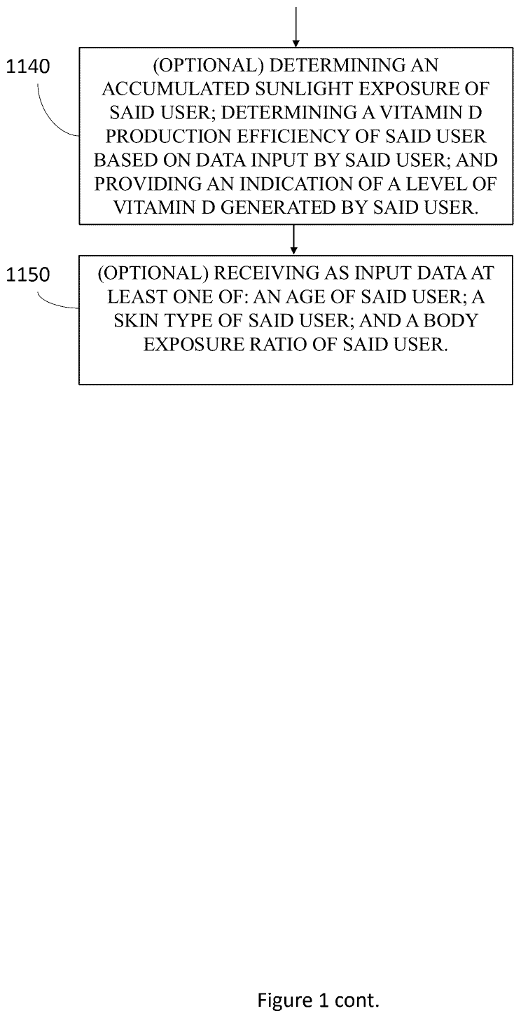

FIG. 1 shows a flow chart outlining a Method 1000 which allows personal environmental monitoring by a user, for example to monitor exposure to sunlight. Method 1000 may be implemented by one or more computer processors as part of an application (app) for a mobile device such as a mobile phone. It is assumed that the user of a mobile device is in the same vicinity as the mobile device, and so determinations made by the app about local environmental conditions in the vicinity apply also to the user of the mobile device.

Method 1000 determines an ultraviolet index (UVI) in the vicinity of the mobile device (1010). Method 1000 may make this determination based on data received from the mobile device. This data may include at least one of: a current time received from a clock of the mobile device; and a geolocation and/or altitude of the mobile device received from a GPS system of the mobile device. This data may be used by the app to determine at least one of: a total ozone column; an aerosol optical depth; and a surface albedo in the vicinity of the mobile device (1070). For example, geolocation data received from the mobile device may indicate that the mobile device (and subsequently the user) is nearby a swimming pool, ski resort or beach which will affect the local surface albedo and thus affect an accurate local UVI in the vicinity of the mobile device.

Additionally, or complementarily, Method 1000 may be capable of utilising a network capability of the mobile device to determine at least one of: a total ozone column; and an aerosol optical depth in the vicinity of the mobile device, and to continually receive an accurate update for at least one of the aforementioned (1080). Method 1000 may also utilise a network capability of the mobile device to determine a surface albedo in the vicinity of the mobile device, for example a picture of a swimming pool that is on a network cloud may be correlated with the geo-topology to determine a local surface albedo.

Method 1000 further determines a modified ultraviolet index (m-UVI), modified in respect of further local conditions of the mobile device and of the user, based on at least one of: further data received from the mobile device; and data input by the user (1020). For example, processors implementing Method 1000 may receive further data from one or more light sensors, accelerometers or audio sensors of the mobile device (1090) and may receive wifi data (1100). Such further data may be used to determine if the mobile device is inside or outdoors (1110), or, for example, in a pocket or handbag. Reverberation provides a particularly good estimation of whether the phone is indoors or outdoors. The app may calculate a “worst case scenario” that a user is in full sun during a period of indoor or “pocketed” use unless data from very near phones, e.g. Bluetooth distance, that are measuring qualified levels of sunlight is available.

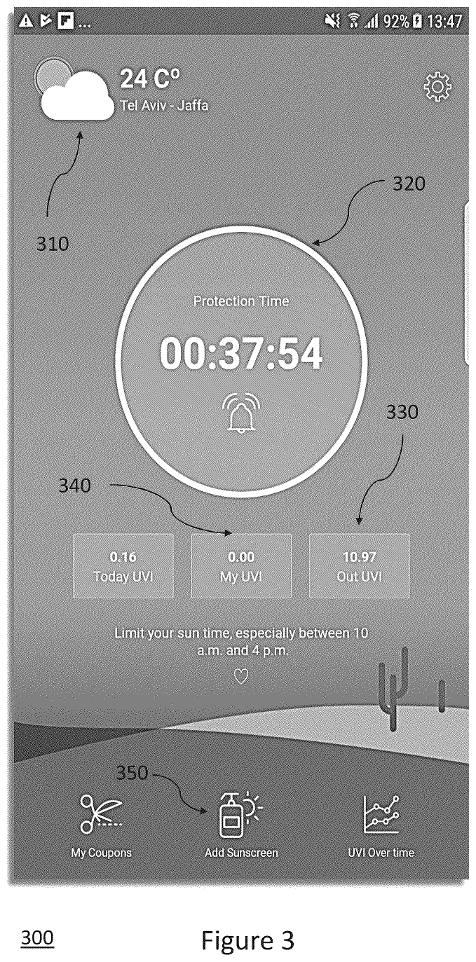

Method 1000 may use one or more processors to determine a predicted exposure of a user of a mobile device based on the determined m-UVI (1030) and may present this to a user via a user interface (UI) 300, see FIG. 3. Method 1000 may also involve a step of determining a minimal erythemal dose (MED) based on an input skin type of the user (1040). In operation, the app executing Method 1000 may present the user with a Fitzpatrick skin type questionnaire to determine an input skin type of the user. The app may present the user's MED to them via the UI 300.

Method 1000 involves providing an erythema timer, based on the determined m-UVI and MED (1050). The timer may be a countdown and may represent a protection time before the onset of erythema/sunburn. The user may declare effective sunscreen and thus affect the m-UVI and subsequently the erythema timer. The user may input to the app a sun protection factor (SPF) of the sunscreen that has been applied (1120). During the sunscreen's effective duration (defined by the sunscreen manufacturer), the app may decrease the modified UVI in proportion with the input SPF, reducing the UV energy flux that is counted by the erythema timer. Before the end of the sunscreen's duration time, the app may issue an alert or notification to the user (1130). If no further action is taken by the user by the end of the duration time, the timer will return to the unprotected value.

Method 1000 may include continually updating the erythema timer based on changing environmental or user conditions (1060), such as cloud cover, and application/reapplication of effective sunscreen.

Method 1000 may also be useful for providing a user with a level of vitamin D their body has produced. Method 1000 may involve using at least one processor to: determine an accumulated sunlight exposure of the user, determine a vitamin D production efficiency of the user based on data input by the user; and may provide an indication of a level of vitamin D generated by the user (1140). The app may present each of the aforementioned to the user via the UI 300.

The production rate of vitamin D is proportional to the exposed skin surface, commonly approximated as a Body Exposure Ratio, i.e. the fraction of the user's body that is exposed to sunlight. The Body Exposure Ratio may be input by the user, or automatically estimated by the app based on known external conditions e.g. season, temperature, environmental context etc.

Vitamin D production is also affected by age, decreasing as a user becomes older. The app may receive as input the user's age in order to provide an indication of a level of vitamin D generated by the user.

As previously mentioned, a user may input their skin type based on the Fitzpatrick skin type scale, and this data may also be used in order to provide an indication of a level of vitamin D generated by the user.

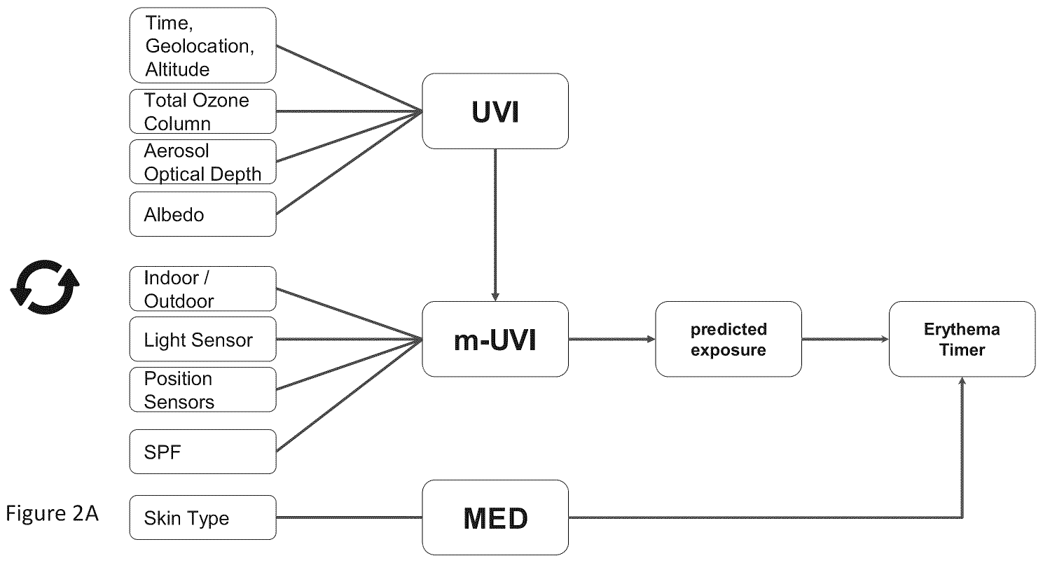

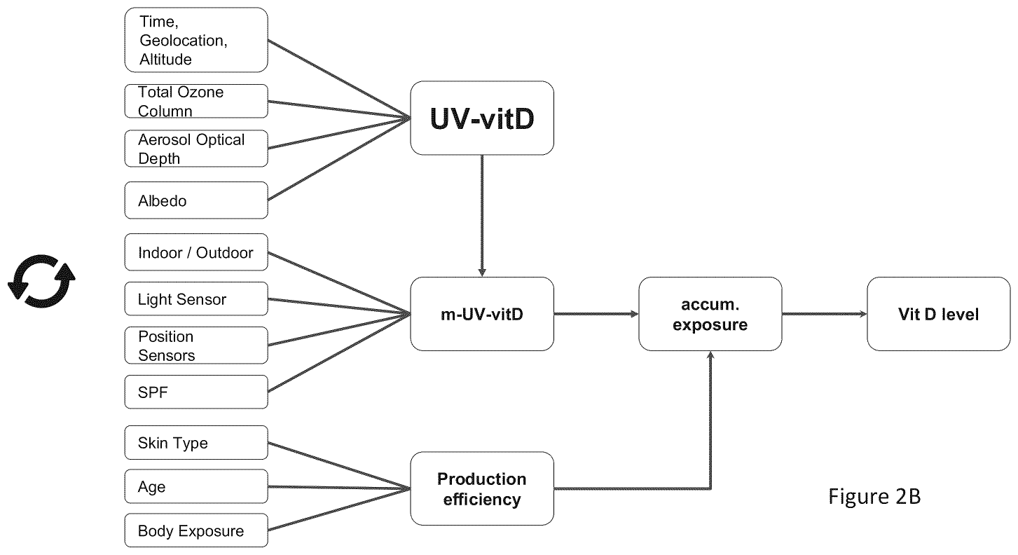

FIGS. 2A and 2B show exemplary data flows as may be used by an app using processors to implement method steps as disclosed herein. Data may be continually received and updated (as represented by the rotating arrows) so as to provide the most accurate and up-to-date environmental and/or user information.

FIG. 3 is an example of a possible user interface (UI) 300 of an app executing method steps as described herein. UI 300 may present a current weather condition and temperature (310). UI 300 may present a protection time corresponding to an erythema timer (320). UI 300 may present a UVI (330) and a personal UVI (m-UVI) (340). UI 300 may allow a user to input effective sunscreen (350).

In accordance with embodiments of the invention there is also provided a system for personal environmental monitoring using a mobile device, the system comprising: a memory; and at least one processor configured to carry out methods as disclosed herein.

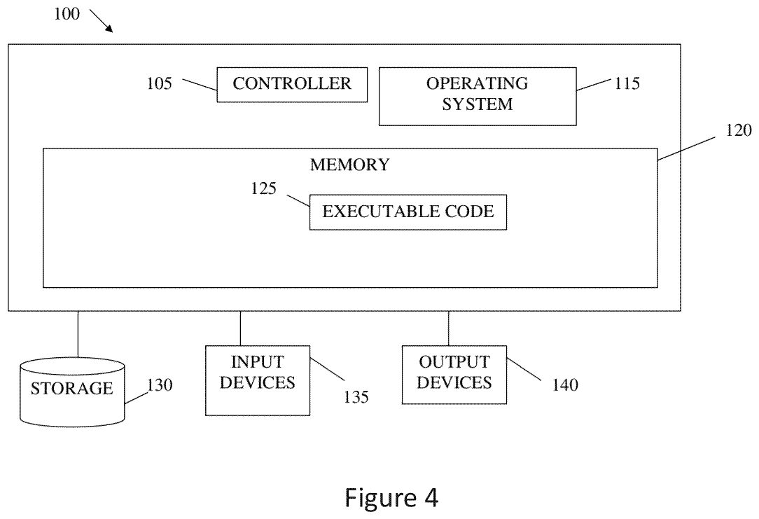

FIG. 4 shows a high-level block diagram of an exemplary computing device such as a mobile phone which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of possibly different memory units. Memory 120 may store for example, instructions (e.g. code 125) to carry out a method as disclosed herein, and/or data such as low-level action data, output data, etc.

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example FIG. 1, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used and may be connected to a network and used as a system. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as user action data or output data may be stored in a storage 130 and may be loaded from storage 130 into a memory 120 where it may be processed by controller 105. In some embodiments, some of the components shown in FIG. 4 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Embodiments of the invention improve technology by utilising various sensors of a mobile device that ordinarily work in isolation, uniting their outputs so as to provide a user-friendly personal health monitor.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment or flowchart can be combined with or used with features or elements described with respect to other embodiments.

Although embodiments of the invention are not limited in this regard, discussions utilizing terms such as, for example, “processing”, “computing”, “calculating”, “determining”, “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method of personal environmental monitoring using a mobile device, the method comprising:
using a processor, determining an ultraviolet index, “UVI”, in the vicinity of said mobile device, based on data received from said mobile device;
using a processor, determining a modified UVI, “m-UVI”, based on at least one of further data received from said mobile device and data input by a user of said mobile device;
using a processor, determining a predicted exposure of said user of said mobile device, based on said m-UVI;
using a processor, determining a minimal erythemal dose, “MED”, of said user based on an input skin type of said user;
using a processor, providing an erythema timer based on said m-UVI and said MED; and
using a processor, continually updating said erythema timer based on changing environmental or user conditions,
wherein said received data corresponds to at least one of: a current time; a geolocation of said mobile device; and an altitude of said mobile device.

2. The method of claim 1 wherein said received data is used by a processor to determine at least one of: a total ozone column; an aerosol optical depth; and a surface albedo in the vicinity of said mobile device.

3. The method of claim 1 wherein a network capability of said mobile device is used by a processor to determine at least one of: a total ozone column; and an aerosol optical depth in the vicinity of said mobile device, and to continually receive an accurate update for at least one of the aforementioned.

4. The method of claim 1 wherein said received further data comprises data received from at least one of: one or more light sensors of said mobile device; one or more accelerometers of said mobile device; and one or more audio sensors of said mobile device.

5. The method of claim 1 wherein said received further data comprises Wi-Fi data of said mobile device.

6. The method of claim 1 wherein said received further data is used to determine if said mobile device is outdoors or indoors.

7. The method of claim 1 wherein said data input by said user for determining said m-UVI comprises a sun protection factor “SPF” of a sunscreen applied by said user.

8. The method of claim 7 wherein said user is issued with an alert before the end of an effective duration of said sunscreen.

9. The method of claim 1 wherein the method further comprises: using a processor, determining an accumulated sunlight exposure of said user; determining a vitamin D production efficiency of said user based on data input by said user; and providing an indication of a level of vitamin D generated by said user.

10. The method of claim 9 wherein said data input by said user comprises at least one of: an age of said user; a skin type of said user; and a body exposure ratio of said user.

11. A non-transitory computer readable medium for personal environmental monitoring, the computer readable medium comprising a set of instructions that, when executed, cause at least one computer processor to:
determine an ultraviolet index, “UVI”, in the vicinity of said mobile device, based on data received from said mobile device; determine a modified UVI, “m-UVI”, based on at least one of further data received from said mobile device and data input by a user of said mobile device;
determine a predicted exposure of said user of said mobile device, based on said m-UVI;
determine a minimal erythemal dose, “MED”, of said user based on an input skin type of said user;
provide an erythema timer based on said m-UVI and said MED; and
continually update said erythema timer based on changing environmental or user conditions,
wherein said received data corresponds to at least one of: a current time; a geolocation of said mobile device; and an altitude of said mobile device.

12. A system for personal environmental monitoring using a mobile device, the system comprising:
a memory; and
at least one processor configured to:
determine an ultraviolet index, “UVI”, in the vicinity of said mobile device, based on data received from said mobile device;
determine a modified UVI, “m-UVI”, based on at least one of further data received from said mobile device and data input by a user of said mobile device;
determine a predicted exposure of said user of said mobile device, based on said m-UVI;
determine a minimal erythemal dose, “MED”, of said user based on an input skin type of said user;
provide an erythema timer based on said m-UVI and said MED; and
continually update said erythema timer based on changing environmental or user conditions,
wherein said received data corresponds to at least one of: a current time; a geolocation of said mobile device; and an altitude of said mobile device.

13. The system of claim 1 wherein said received data is used by a processor to determine at least one of: a total ozone column; an aerosol optical depth; and a surface albedo in the vicinity of said mobile device.

14. The system of claim 1 wherein a processor is configured to utilise a network capability of said mobile device to determine at least one of: a total ozone column; and an aerosol optical depth in the vicinity of said mobile device, and to continually receive an accurate update for at least one of the aforementioned.

15. The system of claim 1 wherein said received further data comprises data received from at least one of: one or more light sensors of said mobile device; one or more accelerometers of said mobile device; and one or more audio sensors of said mobile device.

16. The system of claim 1 wherein said received further data comprises Wi-Fi data of said mobile device.

17. The system of claim 1 wherein said data input by said user for determining said m-UVI comprises a sun protection factor “SPF” of a sunscreen applied by said user.

18. The system of claim 7 wherein said user receives a notification before the end of an effective duration of said sunscreen.

19. The system of claim 1 wherein the system further comprises: at least one processor configured to determine an accumulated sunlight exposure of said user; at least one processor configured to determine a vitamin D production efficiency of said user based on data input by said user; and at least one processor configured to provide an indication of a level of vitamin D generated by said user.

20. The system of claim 9 wherein said data input by said user comprises at least one of: an age of said user; a skin type of said user; and a body exposure ratio of said user.
